(19) United States
(12) Patent Application Publication
(10) Pub. No.: US 2005/0226373 A1
(43) Pub. Date: Oct. 13, 2005

(54) Portable x-ray fluorescence using machine source

(76) Inventors: Jacob I. Trombka, Rockville, MD (US); Samuel R. Floyd, Columbia, MD (US); Jeffrey Schweitzer, Ridgefield, CT (US); Yossi Eisen, Nez Ziona (IL); Timothy P. McClanahan, Columbia, MD (US); Arthur P. Ruitberg, Germantown, MD (US)

Correspondence Address: NASA GODDARD SPACE FLIGHT CENTER, 8800 GREENBELT ROAD, MAIL CODE 140.1, GREENBELT, MD, 20771, US

(21) Appl. No.: 10/955,586

(22) Filed: Sep. 22, 2004

Related U.S. Application Data
(60) Provisional application No. 60/505,728, filed on Sep. 22, 2003.

(51) Int. Cl. G01T 1/36; G01N 23/20; G01N 23/223

(52) U.S. Cl. 378/44

(57) ABSTRACT

Disclosed are systems and systems for in-situ chemical analysis at remote locations.

This Application claims the benefit of Application Ser. No. 60/505,728 filed Sep. 22, 2003 for PORTABLE RUGGED LOW POWERED X-RAY FLUORESCENT USING MACHINE SOURCE, the contents of which are herein incorporated by reference.

### BACKGROUND OF THE INVENTION

1. Field of the Invention

This invention relates generally to systems and methods for chemical analysis and, more particularly, to systems and methods employing x-ray fluorescence for chemical analysis.

2. Description of Related Art

In-situ elemental analysis of materials is useful in diverse applications, such as analysis at forensic sites or on planetary lander missions. Such remote locations, however, present certain limitations and problems for conventional equipment and methods.

### SUMMARY OF THE INVENTION

It is an object of the present invention to provide systems and methods for in-situ chemical analysis at remote locations.

To achieve this and other objects of the present invention, an instrument comprises a housing; a handle; a radiation source; and a radiation detector,

wherein the perimeter of the housing defines a plane, and the instrument further includes a specimen holder configured to hold a specimen substantially in the plane.

According to another aspect of the present invention, an instrument comprises a housing; a handle; a supply circuit for generating a variable voltage from approximately 10 kv to 60 kv, up to approximately 100 milliamps; an x-ray generator, configured to receive power from the supply circuit, employing a 60 kv excitation voltage, the generator including metal ceramic and end window targets constructed with a target material consistent with non-interference with sample fluorescent x-rays, and a photodiode to excite electron emission from a photoelectric surface; a protect circuit to prevent tube arching, if the current to the photodiode diode shuts off, wherein the perimeter of the housing defines a plane, and the instrument further includes a specimen holder configured to hold a specimen approximately in the plane; a channel opposing the generator, through the plane; and an x-ray detector configured to detect radiation from na and up, the detector including a schottky cadmium zinc element; and a thermoelectric element for cooling the detector.

### BRIEF DESCRIPTION OF THE DRAWINGS

References are made to the following text taken in connection with the accompanying drawings, in which:

FIG. 1 is a diagram showing an exemplary system according to a preferred embodiment of the present invention.

FIG. 2 is an exploded view corresponding to FIG. 1

FIG. 3 is a diagram emphasizing other aspects of the exemplary system.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

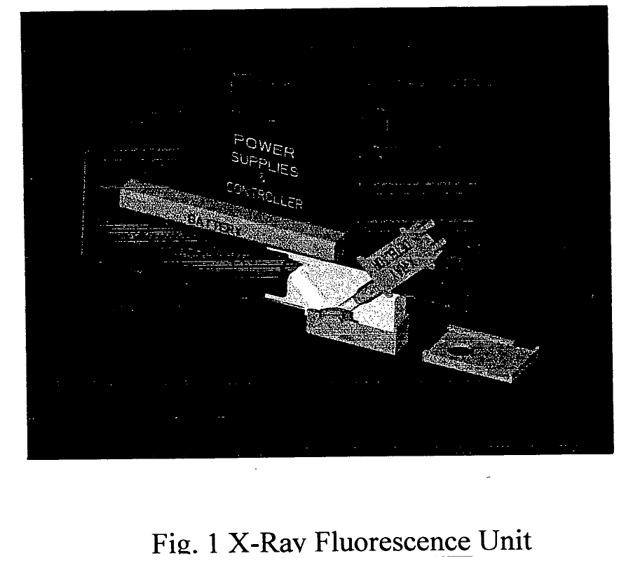

FIG. 1 shows an exemplary portable x-ray fluorescence (XRF) unit 1 for field use, according to a preferred embodiment of the present invention. Unit 1 is rugged, self-contained, portable, and operates at low power.

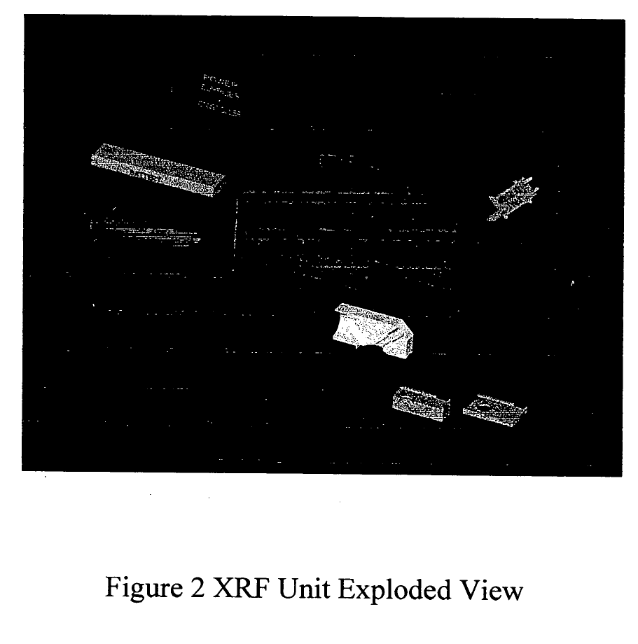

FIG. 2 is an exploded view corresponding to FIG. 1

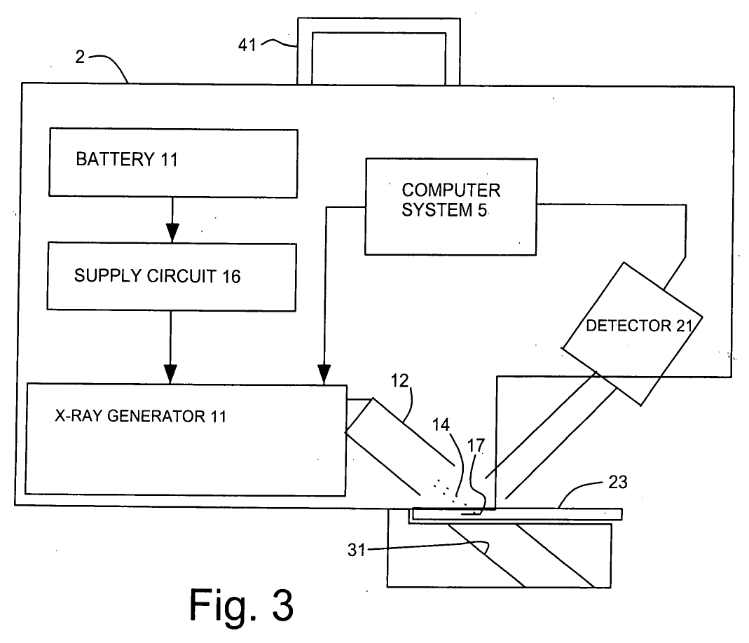

FIG. 3 is a diagram emphasizing other aspects of the exemplary unit 1. Housing 2, having handle 41, is the size of a briefcase. Handle 41 can support the weight of housing 2 and the elements enclosed by housing 2.

Unit 1 can measure concentrations of such elements as Ba and Sb (important in the detection of gun powder residue detection) down to milligrams concentrations.

Battery 11 and voltage step up circuit 16 supply power to x-ray generator 11. X-ray generator 11 operates up to 60 KV and 100 milliamps.

Digital computer system 5 enables automated calibration, health of the unit, data accumulation, data analysis, data storage, data transmission, and acquisition systems to be integrated into unit 1.

The software in computer system 5 can be remotely updated and the system operation can also be remotely operated and controlled.

X-ray detector 21 includes a Schottky Cadmium Telluride element. X-ray detector 21 is configured to measure x-ray lines up to 30 keV, thus enabling measurement of k-line emissions of the heavier elements.

Channel 31 acts as a beam catcher, to reduce x-ray source scatter into the detector 21.

X-rays emitted from barrel 12 irradiate sample 17, on holder 23, to cause characteristic emissions from the elements in sample 17. The excitation is produced by x-rays interacting with orbital x-rays in the k, 1, m etc. shells of the atom. In order to interact to produce fluorescence, the x-rays have energies in excess of the binding energy of the particular atomic shell. The higher the Z of the element, the higher the energy required to excite characteristic fluorescence. The fluorescence yield of x-ray is highest for k shell emissions and decreases for the 1, m etc shells. The k shell energy excitation and line emission is higher energy than the 1, m, etc. shells.

X-ray generator 11 employs a 60 KV excitation voltage, operating at approximately 100 milliamps. X-ray generator 11 includes metal ceramic and end window targets constructed with a target material consistent with non-interference with sample fluorescent X-rays. The tube is hardened for operations in extreme environments.

X-ray Generator 11 includes a photodiode to excite electron emission from a photoelectric surface. If the current to the diode shuts off, there is a protect circuit to prevent tube arching.

Supply circuit 16 generates a variable voltage from approximately 10 KV to 60 KV. Current is variable up to approximately 100 milliamps.

There is a protect on the operation of supply circuit 16 such that it cannot operate until the system is properly radiation shielded.

X-Ray Detector 21 is configured to detect radiation from Na and up. X-ray detector 21 is solid-state. Detector 21 includes a Schottky cadmium zinc (CZ) element.

Detector 21 is cooled to enhance energy resolution. Operation in the −5C to −10 C is accomplished using a thermoelectric cooler.

The sampling system will now be described. The detector system is configured to allow for a sample to be introduced into a chamber (internal sample), or analyzed directly by surface irradiation (surface sample). The greatest sensitivity for detection of milligram concentration is achieved when the internal sample system is used.

Using the internal sample, the exemplary system employs a beam dump, according to which the sample is collected on a thin specimen holder 23 and placed on a stage. Channel 31 acts as a “beam catcher.” Channel 31, under the sample stage, is angled and shielded such that detector 21 cannot see the scattered radiation. Thus, most of the excitation beam 14 passes through and is not reflected in the direction of detector 21, thus substantially suppressing background.

The analysis of a Low Z sample will now be described. X-ray with energies below that of Fe (approximately 6 keV) are easily absorbed by air. In order to measure the elemental composition of elements such as Na, Mg, Si, S, and Ca, measurements is made in either vacuum or in a reduced density atmosphere such as that which can be achieved using He atmosphere. The system can be operated in either in vacuum or in a He atmosphere.

The analysis of a surface sample will now be described. In many cases where sample cannot be extracted for the region of interest or pretested before extraction, direct irradiation of the sample is required. The unit has a sample stage that can replace the internal sample stage to allow for direct surface irradiation.

The system is radiation-shielded to provide environmental protection, and to ensure that the radiation levels external to the unit comply with government standards both federal and local. Properly shielded sample stages both internal and surface will and surface are configured to be radiation level compliant and the system cannot be operated unless the shields are properly engaged.

The system includes dosimeters to monitor radiation background at critical areas around the system. The dosimeters provide real time monitoring of radiation levels. Small solid state detector systems are presently available for this purpose.

The exemplary system is operated through digital control systems controllable by investigators in the field or at sites remote from the detection system. The operating system is programmable either at the site or remotely.

The exemplary system is configured for calibration of the power supply control and the instrument controls. The instrument controls include the X-ray generator control and the detector controls.

Human interfaces include software applications and hardware. Software applications include instrument control with dynamic material sampling configuration controls, health of experiment, maintenance, data analysis, radiation shielding monitors, and telecommunications. Hardware includes a touchscreen or flatsreen display interface, and analog buttons and knobs.

Communications Interfaces include telecommunications, global positioning system, and telecommunications security.

Internal data analysis includes spectral deconvolution, and data storage.

The computer system includes a processor, communications Interface, Personal Data Assistant, harddrive, and CD/DVD Drive.

The exemplary system includes an AC/DC Interface.

The exemplary system may be used to perform non-destructive analysis of physical evidence at crime scenes, including explosion sites. The use of this may also be of interest for homeland security, anti-terrorism, and weapons of mass destruction.

The exemplary system may be used to detect of art fraud.

The exemplary system may be used to monitor products for on-line quality control.

Thus unit 1 performs non-destructive elemental analyses of material of interest in such programs as forensic, planetary, home security, weapons of mass destruction, and nuclear non-proliferation investigations.

The elements in housing 2 may be operated as for example, on planetary lander missions or be used in field situations, as for example, at crime or bomb scenes by operators not necessarily trained in the sciences and engineering usually needed for proper operation of such equipment. The system is calibrated prior to use in the field automatically or remotely and the health of the system is determined and corrective steps taken if necessary. Data analysis and databases are available at the site or by connection to sites where analysis and interpretation can be carried out in near real time.

Thus, the exemplary systems allow for more effective investigation of the environment and aid in the selection and collection of important materials relative to the investigation.

Thus, the exemplary systems provide a portable field X-Ray Fluorescence (XRF) system capable of performing analysis of selected materials down to the parts per million (ppm) leVels for a large number of critical elements of interest in forensic and space exploration applications. The system is configured so that operation can be carried with investigators who may not be trained experts in the field of XRF analysis and may not have scientific and engineering training.

In a number environments of interest, radiation damage can degrade the operation of the detector. The exemplary systems may employ annealing to recover operation of the detector. By reversing the current of the cooler, heating can be achieved.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

1. An instrument comprising:
a housing;
a handle;
a radiation source; and
a radiation detector,
wherein the perimeter of the housing defines a plane, and the instrument further includes a specimen holder configured to hold a specimen substantially in the plane.

2. An instrument comprising:
a housing;
a handle;
a supply circuit for generating a variable voltage from approximately 10 kv to 60 kv, up to approximately 100 milliamps;
an x-ray generator, configured to receive power from the supply circuit, employing a 60 kv excitation voltage, the generator including metal ceramic and end window targets constructed with a target material consistent with non-interference with sample fluorescent x-rays, and a photodiode to excite electron emission from a photoelectric surface;
a protect circuit to prevent tube arching, if the current to the photodiode diode shuts off,
wherein the perimeter of the housing defines a plane, and the instrument further includes
a specimen holder configured to hold a specimen approximately in the plane;
a channel opposing the generator, through the plane; and
an x-ray detector configured to detect radiation from na and up, the detector including a schottky cadmium zinc element; and
a thermoelectric element for cooling the detector.
